(19) United States
(12) Patent Application Publication
(10) Pub. No.: US 2023/0055780 A1
(43) Pub. Date: Feb. 23, 2023

(54) METHOD AND SYSTEM FOR TARGETED CONSUMER ENGAGEMENT USING SERIALIZED PRODUCTS

(71) Applicant: KEZZLER AS, Oslo (NO)

(72) Inventor: Magnar LØKEN, Oslo (NO)

(73) Assignee: KEZZLER AS, Oslo (NO)

(21) Appl. No.: 17/574,352

(22) Filed: Jan. 12, 2022

(30) Foreign Application Priority Data
Aug. 23, 2021 (NO) 20211011

(51) Int. Cl. G06Q 30/02

(52) U.S. Cl. CPC G06Q 30/0258; G06Q 30/0212; G06Q 30/0252

(57) ABSTRACT

A computer implemented consumer engagement system for managing a campaign offer includes a computer implemented consumer engagement system; and a pool of unique codes related to code marked product items, the code marked product items being associated with a campaign offer of a campaign in the consumer engagement system. The consumer engagement system is arranged to manage at least one geolocation condition, and to deliver a campaign participation invitation to a potential qualifiable recipient, wherein the potentially qualifiable recipient in order to become a qualified recipient for receiving the campaign offer, must meet the following qualification criteria: (a) a pool criterium: the system receiving a unique product code marked on a product item from the recipient, the code being determined to be amongst the pool of unique codes; (b) a time criterium: that the consumer sends his participation request (or accepts an invitation) to participate at a point of time within a first time period defined in the campaign; and a geolocation condition criterium: receiving proof or indications from the recipient being present and having a position within a geolocation. The consumer engagement system is further arranged for, the qualifiable recipient, after receiving a campaign participation invitation, to receive from said qualifiable recipient a participation request, i.e. accept said campaign participation invitation. The consumer engagement system is further arranged to check whether the potentially qualifiable consumer thus fulfills criteria (a), (b), and (c), thus becoming a qualified recipient, thus fulfilling (d) an execution list criterium: wherein the recipient is registered on an execution list to receive said campaign offer.

### INTRODUCTION

The invention is concerned with using a unique code associated with a product item to enhance and improve marketing of products and brands. The present invention will benefit the proliferation of smartphones, apps and mobile Internet, and is enabling brand owners to run targeted marketing campaigns where consumers are motivated to interact with their product items.

The Problem

The use and consumption of what is normally referred to as “linear” television has been rapidly declining after the introduction of the Internet and smartphones. Most people now will choose for themselves what they want to watch on the screen, they will select their own content when it comes to movies, news, documentaries, shows and so on. Not only will they choose what they want to watch, but also when and where to watch it. The platform on which they watch “television” is predominantly via computer devices connected to the Internet and on their smartphones on the move as they travel, work or stay at home. These consumers of television are now much more in control of how the content is presented, and for instance they can pause what they are watching at any time.

Another development with the introduction of the Internet and digitalization is that printed media consumption is also rapidly decreasing.

For brand owners, this has created some new problems when they are marketing their products and services. Advertisements in printed media such as newspapers and magazines are “slow”, static and viewed by less and less people making this traditional marketing method much less efficient than what used to be.

The traditional advertisements and mass marketing on television has also become less efficient since the consumers in most cases can skip and avoid advertisements on the screen. When consumers pay for streaming content on for instance Netflix, part of the agreement is that no commercials are presented to viewers.

In addition, another problem faced by brands in terms of marketing is that the brand owners are virtually not present at the moment when the consumer is purchasing or in some way using their products. However, a recent trend is that more and more product items are now being marked with unique codes, marketing labels, “devices” such as for instance QR-codes and augmented reality. This is a way for the brand owner to get in touch with the consumers in a digital way and via their phones or computer devices in general. Some of these new methods are also facilitating a two-way communication and active interaction between the brand and the consumer.

One particular problem with these new digital marketing methods is to sufficiently motivate the consumer to actually use them, and make the consumer experience that they are of value to them. It is still difficult for a brand using these methods to ensure that they take advantage and capture the attention and interest of the consumer during “golden moments,” moments of consumer attention, when a consumer is actually more inclined and interested to interact with the brand. Such moments are for instance when taking a product out of storage, unpacking, consumption and certain situations where the brand is more relevant to the consumer. It is, as an example, feasible to think that a consumer is significantly more interested in a cereal brand in the morning just when having breakfast, or later in the day just when shopping for breakfast for the next day.

Essentially a problem for the brands is therefore to engage the consumers more effectively when the consumer is actually available, and not miss this huge untapped interaction potential with the consumer. Further methods and systems for leading and maneuvering the consumers to interact controlled and commanded by the brand owner is required, as seen from the brand owner's point of view. What is lacking is essentially how brand owners get consumers to interact with their brands and products, and further when, where and how they want the interaction to be.

The current invention solves one or more of these problems and provides a method and system for actively engaging the consumer to interact with the brand by designing, managing and operating a targeted interaction campaign directed at the consumer using uniquely coded product items.

Introduction to the Invention

Product items are now increasingly serialized and marked with a unique code (401) for each product item. Having a unique code (401) for each product item (402) enables the brand owner to track and trace the code marked product (402) in the supply chain and provide granular insight to the lifecycle of a specific code (401) marked identifiable product item (402). A unique and serialized product item (402) makes it possible for the brand owner to accrue detailed information that can be shared and managed with all stakeholders in the supply chain.

The current invention in particular uses serialized product items (402) to motivate and drive consumer (200) engagement. The unique code (401) on the product item (402) represents or carries a value, and/or access to a service that can be harvested by the consumer/holder/owner (200) of the product item (402) by using the unique code (401) associated with the product item (402).

In relation to the present invention, a client (202) is a piece of hardware and/or computer software that is capable of processing computer instructions and computer code and also able to communicate through computer (enabled) networks and thus connect and communicate with other clients, software and computers.

As an example, the client (202) may be a smartphone with an app to interact with a user/consumer (200) and communicate with a system (100) based on the current invention. As a further example it communicates, e.g. scanned serialized unique codes (401) from a product item (402) to a track and trace system (101) of a consumer engagement system (100) run on a server at a (system) specialist vendor, and exchanges information based on the serialized unique code (401). Another term for a serialized unique code (401) is equivalent to unique identification code (401) of each product item (402), sometimes also termed UID.

A user/consumer (200) is a person that can interact with such a client (202) to take advantage of the client's capabilities to perform and operate tasks and functions available by the client (202). When a consumer (200) interacts with a client (202) that interaction is also sometimes referred to as the consumer experience.

A user profile (201) is understood to be an authorization for the consumer (200) to interact with the client and specific and uniquely identifiable information related to the user (200) that will govern the interaction with the client (202). Such user profile information is very commonly comprising; user name, address, user email, mobile phone number, user id assigned within the client, selected user preferences within the client, etc.

Hereafter the terms user (200) and consumer (200) are used interchangeably.

A brand owner wants to engage consumers (200) as a part of their marketing efforts and in turn increase recognition, sales and profits for their brands. Consumer engagement in this context shall be understood to encompass all activities, information and interactions between the consumer and the brand, where a brand owner is successful in enriching and enhancing the consumer's product experience and perception of the brand at a given moment of interaction and also over time. An obvious but simple example of such consumer engagement activity is a web page visit where the consumer can access information about their product—possibly register their product item ownership, get coupons, discounts, or a customer service telephone number where the consumer can call for information and support concerning their products and purchases.

The recent introduction of uniquely code (401) marked product items managed by track and trace systems has expanded the possibilities of what and how the brand owner can run their consumer engagement by using the current invention. All serialized product items are unique by virtue of their unique code (401) and this opens up for consumer engagement where each consumer engagement or consumer interaction can be individualized for each consumer. The unique code (401) on the product item thus might hold, represent or carry a different “value” for every consumer, since the value or offer can be dependent/determined based on the consumer's profile managed by the brand owner.

An appropriate and relevant attribute with unique codes on product items (402) in relation to the current invention—is that the value can be sufficiently controlled and managed by the unique code (401). For instance without this control—any number of Mercedes cars as the first prized could be claimed by any number of consumers (200). Also when the prize or offering (306) is handed out, it's value is “used” or “depleted,” i.e. one unique code (401) means one chance of winning, or one car only can be won per code (401) marked product item (402).

For instance a consumer profile with “Gold” status might be allowed to receive more value than a consumer holding a “Bronze” status for exactly the same unique code (401) associated with the product item (402) for the same campaign (306). In a basic embodiment of the current invention there is no need for the consumer to have a user account or user profile (201) with the consumer engagement system (100), however having a user profile (201) makes it possible to greatly enhance the engagement and user experience based on that user profile (201). However any campaign (306) and engagement as run by the current invention is basically “ad-hoc” and on a case by case manner.

Another advantage realized with the current invention is that when new and rapid market situations occur, the brand owner can react fast and in a flexible but targeted manner to those new market conditions by running a campaign that responds to the new situation.

The ability to adjust and design a communication fast response on “day-to-day” market conditions are one essential for the core of the current invention. As an example, a brand owner realizes that a competitor is very successful in selling turkeys the week before Thanksgiving and this is impacting his brands sales significantly. His brand thus has a huge overstock of competing turkeys for sale. Further, unsold products which are more or less specifically intended for use on the Thanksgiving Day are somewhat similar to a “flight already taken off—unoccupied seat direct loss” scenario where there is a distinct before and after correlation in terms of the consumer's interest to buy the product. Using the current invention's fast and flexible core capability—the brand runs a campaign to counteract sluggish sales, wherein the campaign offer (303) may comprise that the consumer is offered 50% on a purchase within 24 hours, and a 50% coupon for a second purchase within the next 12 months.

Arguably, the best time for the brand owner to interact and engage with the consumer is when the consumer (200) is using the unique code (401) on the product item (402) since the consumer's (200) attention and mind is at this moment directed and focused at the brand and product item (402).

There is therefore a huge untapped potential in using the uniquely coded (401) product item (402) by operating a “call to action” and “do it now!” type of campaign (306) directed at consumers (200). The nature of this category of special marketing campaigns according to the current invention are limited both in terms of time and/or location since the brand is asking the consumer (200) to, in essence, react in order to get special rewards. For the consumer (200) that might want to interact or take the call to action—he or she has to fulfill and meet certain criteria (600, 500, 700), set by the brand owner—predominantly to be present at a certain place (601) and also sometimes at a given time (508), i.e. within a time span (506), and sometimes both those criteria (600, 500) in combination.

The urgency and fun factor created by this type of marketing, is something that the brand can benefit from since it makes the consumer possibly interact when they otherwise might not have done so. It also motivates the consumer (200) to act more quickly since the offer might “go away” if they do not act.

In general terms such marketing campaigns by using the current invention as described are mostly focused around some type of event or occasion. An event where such consumer engagement might be desirable is a sports event at a sports stadium, which is usually generally confined to a stadium, or the celebration of Thanksgiving, which is for most potential consumers confined by a time expiry. Particularly the invention thus describes a method that makes it possible to design and run special consumer engagement campaigns at all types of events, such as typical sport events, concerts, seminars, celebrations, parties and so on. For the purpose and context for the current invention, an event is simply to be understood as a constructed occasion or situation as defined by the brand owner that sufficiently describes and defines a logical frame for running a consumer engagement campaign. By such an understanding, an “event” is associated with the term “campaign” for understanding the current invention.

One problem with this type of consumer engagement is that the “call to action” criteria and additional context required to be met by the consumer is very difficult or near impossible to control and manage in practice with traditional methods and systems.

### BRIEF SUMMARY OF THE INVENTION

The invention provides a computer implemented consumer engagement system and a computer implemented consumer engagement method, both for managing a campaign offer (303). Those are defined in the independent claims. Further embodiments of the invention are defined in the dependent claims.

The invention provides a computer implemented consumer engagement system (100) for managing a campaign offer (303), comprising
a computer implemented consumer engagement system (100),
a pool (404) of unique codes (401) related to code marked product items (402) which are associated with a campaign's (306) campaign offer (303) in said consumer engagement system (100),
said consumer engagement system (100) arranged to manage at least one geolocation condition (600), and to deliver a campaign participation invitation (305) to a potential qualifiable recipient (201), wherein said potentially qualifiable recipient (201) in order to become a qualified recipient (202) for receiving said campaign offer (303), must meet the following qualification criteria:
(a) a pool criterium (400): said system receiving a unique product code (401) marked on a product item (402) from said recipient (201, 202), said code (401) being determined to be amongst said pool (404) of unique codes (401); and
   (b) a time criterium (500): that the consumer (200) sends his participation request (301) (or accepts an invitation) to participate at a point of time (508) within a first time period (506) defined in the campaign (306); and
   (c) a geolocation condition (600) criterium: receiving proof or indications from the recipient (201, 202) being present and having a position (602) within a geolocation (601);

further arranged for, said qualifiable recipient (201), after receiving a campaign participation invitation (305), to receive from said qualifiable recipient (201) a participation request (301), i.e. accept said campaign participation invitation (305),

said consumer engagement arranged to check whether the potentially qualifiable consumer (201) thus fulfills criteria (a), (b), and (c) thus becomes a qualified recipient (202), thus fulfilling (d) an execution list criterium (700): wherein the recipient (201, 202) is registered on an execution list (710) to receive said campaign offer (303).

The invention further provides a computer implemented consumer engagement method for managing a campaign offer (303), comprising
in a computer implemented consumer engagement system (100),
establishing a pool (404) of unique codes (401) related to code marked product items (402) associated with a campaign's (306) campaign offer (303) in said consumer engagement system (100),

establishing in said consumer engagement system (100) the following qualification criteria (400, 500, 600) for a potentially qualifiable recipient (201):
(a) a pool criterium (400): whether a submitted code (403) is in said pool (404) of unique codes (401); and
   (b) a time criterium (500): whether the qualifiable recipient (201) sends a participation request (301) (or accepts an invitation by submitting the participation request (301)) within a first time period (506) defined in the campaign (306); and
   (c) a geolocation (600) criterium: whether the potentially qualifiable recipient (201) provides a position (602) which is within a geolocation (601);

said consumer engagement system (100) provides a campaign participation invitation (305) to said potentially qualifiable recipient (201),
said consumer engagement system (100) receives a participation request (301) from said potentially qualifiable recipient (201) having been given said campaign participation invitation (305) in order to become a qualified recipient (202);
said participation request (301) comprising
   a code (403) read from an item,
   a point of time (508) for submitting the request (301);
   a position (602) of said potentially qualifiable recipient (201);

if said consumer engagement system (100) determines said potentially qualifiable recipient (201) meets said qualification criteria (400, 500, 600), determine said potentially qualifiable recipient (201) to fulfil an execution list criterium (700) and be a qualified recipient (202) to enter an execution list (710) to receive the campaign offer (303),

deliver said campaign offer (303) to said qualified recipient (202).

### BRIEF FIGURE CAPTIONS

FIG. 1 is an overview of the basic features related to the invention, but also an illustration of the invention. In FIG. 1 we have illustrated an outline plan of a geolocation (601) such as a stadium with stadium walls representing a border (622) of the geolocation (601).

FIG. 2 illustrates the criteria (600, 500, 400) for potential recipients (201) to become qualified recipients (203). Further illustrated is a geolocation (601) within a border of said geolocation (600).

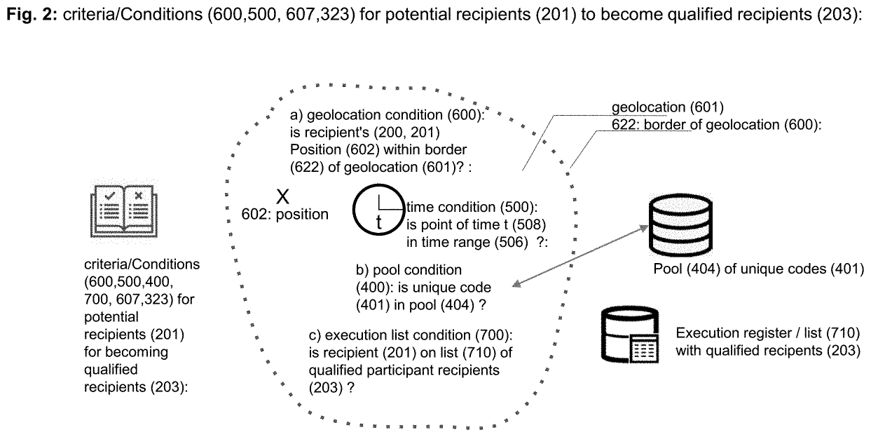

FIG. 3 is an illustration of the invention wherein is indicated a consumer engagement system (100) with a campaign (306) implemented, a pool (404) of unique codes related to code marked items (402), a geolocation (601) with a border (622), here illustrated as the perimeter of a stadium, and a potential recipient (601) present at the stadium, and having an item (402) from which he may retrieve a unique code (401). The recipient (201) receives a campaign invitation (305) from the consumer engagement system (100), provides, as a response, the code (401) in a participation request (301) back to the consumer engagement system (100), which system checks and determines whether the potentially qualifiable recipient (201) becomes a qualified recipient (202) by satisfying the criteria (600, 500, 400), in order to receive the campaign offer (303).

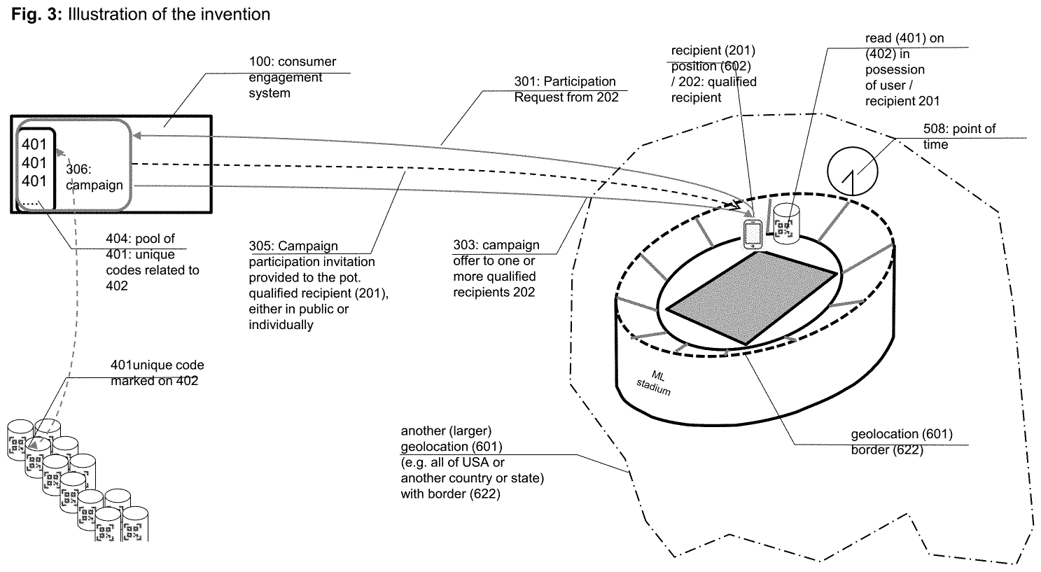

FIG. 4 is a list of components involved in the invention

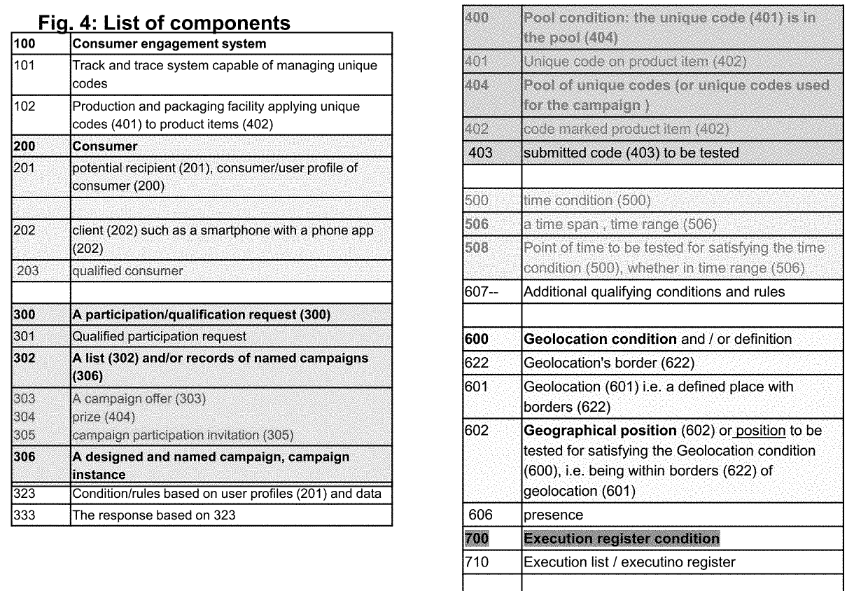

### DESCRIPTION OF EMBODIMENT THE INVENTION

To take advantage of the current invention, a brand owner must operate a track and trace system (101) based on the use of unique codes (401) of their product items (402). The term “unique” for the feature “unique code” (401) is used in a stringent manner. There is only one product item (402) for a given unique code (401). The unique code (401) may be in plain text such as a batch number combined with a serial number, and the unique code (401) may further be encrypted. A consumer engagement system (100) according to the current invention is a computer implemented method and system where the consumer engagement system (100) comprises all the capabilities and so required functions of a track and trace system (101) as described, and then in particular the management of the unique codes (401) on product items (402). The product items (402) are according to the current invention therefore all uniquely code (401) marked, either with a code label, tamper-free code label, RFID label, gravure, painted label, etc., when going into the market and supply chain, and the track and trace system (101) is capable of managing uniquely code (401) marked product items (402). The current invention will utilize the unique code (401) on the product item (402) as one of the means to verify and qualify that the consumer (200) has fulfilled and met the criteria in order to participate in the campaign and receive the associated campaign offer (303) that the brand owner has set for the campaign (306) in question. The unique code (401) on the product item (402) is effectively an access key for the consumer to initiate entering the campaign.

A non-exhaustive list of examples of such a value, services and benefits associated with the code marked item (402) may be given by the following;
discount coupon codes for being used for additional purchases, or purchases of further items units, or giving access to other services.
a guarantee certificate for the bought code marked item (402),
accessing user instructions for the bought code marked item (402),
participation in general loyalty schemes and programs related to the Brand and not necessarily restricted to the code marked item (402), and the like,
unique information or services related or associated to the unique code (401) marked item (402), such as a pin code (404) for access to the product item (402),
and in general any promise of delivery or benefit that the brand owner wants to give the consumer (200).

One essential purpose of the current invention is to motivate the consumer (200) to engage with the brand by submitting a unique code (401) on a product item (402) to the consumer engagement system (100) that is working in conjunction with a serialization based track and trace system (101). The invention is using certain limitations for the participating so that the consumer (200) must act, in order not to miss the campaign offer's (303) potential value which she is invited to try to qualify to receive. The two most important conditions for participating are the geolocation condition (600): that the consumer (200) provides her position (602) within a defined geolocation (601), and the time condition (500): that she responds at a point of time (508) within a given time span (506). To tell which one of those conditions (600, 500) is the most restrictive of them may depend on the particular campaign. At one end of this spectrum—for a sports event both time span and geolocation may be very “restricted” and limited indeed. In an embodiment of the invention, the consumer must be present within the stadium, a geolocation (601), within a given short time window (506), e.g. a pre-match time window, the match time window, and a reasonable post-match time window, which may be extended in case of extended time of a match such as a cup final, to harvest the campaign value. At the other end of the spectrum a campaign can be “loose” on both location and time, say for a long summer campaign for the entire USA, wherein the geolocation (601) may be simply within a border (622) of the nation, and the time span (506) may be (Jun. 1 to Aug. 31).

An example of how this works will be given by the following example. During the Superbowl, a campaign (306) has a geolocation condition (600) that includes all positions (602) within the entire USA, so in practical terms every consumer within the USA can participate. However, that geolocation criterium (600) in combination with a very short time window (506), a call to action is part of this campaign (306). The consumer (200) can, e.g. win a house worth a million dollars in a prize drawing. In order for being allowed to participate in the drawing, the consumer (200) must scan/submit a unique code (401) from a product item (402) during the Superbowl to the campaign system. *(one may have ownership checks in the system (101) that verifies that the consumer (200) actually is entitled to possess the product item (402) identified by the code (401)). That's basically it. The effectiveness of this campaign is evident; many individuals of the millions of consumers (200) will now go to their fridge, bag, or table, and fetch his/her campaigned, uniquely code (401) marked product items (402) so they can scan the unique code (401) in order to enter the drawing. (An advantage to the Brand owner, chances are now that they might consume this code marked item (402)—which they might not have done if the brand did not run the campaign as per current invention). Further, if the consumer (200) is already considering consuming such a product (402) anyway—she or he might now consume the campaigned, uniquely code (401) marked item (402) instead of choosing a product item from a competing brand. For an event such as the Superbowl, the “extra” consumed inventory volume of “otherwise not activated/consumed” product items (402) might be in the tens of millions and can increase sales and profits by a significant factor.

Activating such masses of consumers and moving such an inventory at the right and optimal moment is possible by using the current invention.

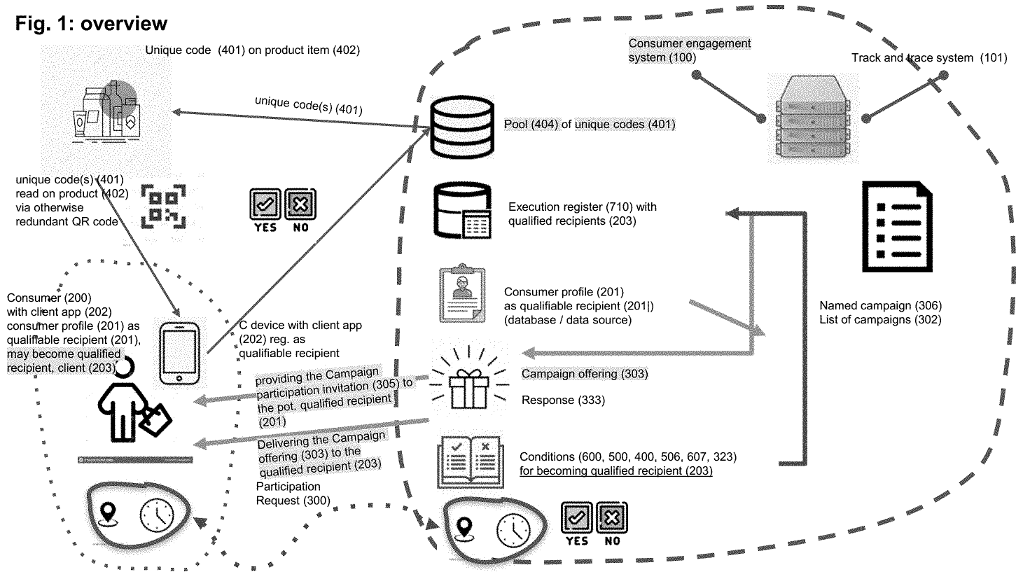

FIG. 1 outlines the components and execution of the current invention.

Preparing a campaign (306) using the current invention requires the brand owner to access the computer implemented consumer engagement system (100) and create a new campaign instance (306) that is going to be executed and operated. Several such campaign instances (306) might be independently operated at any given time so they are normally managed by some identifiable designation in order to separate them from each other, typically by a name or number or both. For instance such a named campaign designation (306) can be “Super Bowl 2022”. A list (302) and/or records of named campaigns (306) and their particulars are managed, (created, updated, deleted, archived, etc.) by the consumer engagement system (100).

The consumer engagement system (100) can be designed so that the brand owner can monitor the campaign (306), its progress and success rate by presenting data (and analytically processed data) and statistics to that effect.

A core feature of the current innovation is that the campaign (606) offering (303) presented to the consumer (200) has conditions (600, 500, 700, . . . ), i.e. the consumer (200) must satisfy a certain behavior dictated by these conditions (600, 500, 700, . . . ) in order to receive the offering (303). The process, actions, outcomes and steps carried out by the consumer, (and the corresponding checking by the consumer engagement system (100), to pass one or more conditions (600, 500, 700, . . . ), is collectively named and referred to as a qualification. A successful qualification allows the consumer to receive the offering (303).

The unique codes (401) on the product items (402) are now (partly) managed by the track and trace coupled with the consumer engagement system (100) and these unique codes are recognized by the consumer engagement system (100) as being in a pool (404) of campaign participating unique codes (401) of product items (402) that are designated for the campaign (306).

In the consumer engagement system (100), a set of geolocation conditions (600) are created. The geolocation condition (600) comprises a geolocation (601), i.e. a defined place such as defined by its borders (622), or a given position with a radius which in practice defines a border (622), to be satisfied or not. In order to satisfy the geolocation condition, the consumer (200) must have a geographical position (602) or otherwise defined position to be tested for whether it is within borders (622) of geolocation (601). The geolocation (601) may comprise a defined area with borders (622), such as a country (601) defined by its borders (622), a city (601) defined by its borders (622), a stadium (601) defined by its perimeter (622). The border of the geolocation (601) may be defined by geofences (622) which may represent imaginary borders (622) that are created, stored and associated with the pool (404) of unique codes (401), and thus also the association with the named campaign (306) has been created, stored and can now be managed. One geolocation condition (600) with associated geolocation definition/condition (601) might be associated and (re)used for several other named campaigns (306) if this is found useful. During the operation of the campaign (306) the unique code (401) recording can be checked against this geolocation condition location (600) as a secondary qualifying condition to enter registration in the campaign.

In much the same manner in the consumer engagement system (100) the brand owner defines and associates a time period condition (500) for the execution of the campaign. The definitions of the point of time (508) and time periods (506) can be implemented in several ways, such as a point of time (508) given by current time (date, month, year, hour, minute), and a time period with a period start time (start date, start month, start year, start hour, start minute) and a period end time (end date, end month, end year, end hour, end minute), according to the invention for those skilled in the art. The main purpose and function is however that when a consumer (200) is interacting with the consumer engagement system (100) to send a “qualification request,” a participation request (301) to qualify to enter the execution list (710), the consumer engagement system (100) will, based on the time condition (500) controlled and checked by the consumer engagement system (100), essentially return a “yes, accepted” or “no, not accepted” response accordingly.

As an example, if the campaign (306) time period definition (506) of a time condition (500) is set up to be a time period definition (506)=Boxing Day 2021, then any attempts to qualify (300) with a point of time (508) before or later than Dec. 25 will have a “no” or “not accepted” outcome. Only qualification/participation requests (301) within the 24 hour time period (506) on Dec. 25, 2021 will produce an affirmative or positive response from the consumer engagement system (100).

The consumer engagement system (100) comprises and manages an execution list (710) also named execution register (710). As consumers (200) are fully qualified becoming qualified consumers (203) thus having passed all the other conditions (600, 500, 507) to participate in the campaign (306) are recorded and registered in the execution register (710). The execution register/list (710) will be the basis and data source for delivering the campaign offering (303) to those qualified consumers (203) enrolled by passing all conditions (600, 500, 507, 700).

The consumer engagement system (100) is arranged to manage all the processes and the systems computer implemented components that are required to execute the campaign (306). This means that for instance both intermediate and “final” data and thus data sources must be managed, for as an example delivering the value to the qualified recipients (203). One particular process is when a consumer submits a participation request (301) with a code (403) which may be a unique code (401) and wants to participate. An identifiable and unique campaign (306) participation entry (201) has to be created and managed. A phone number, IP-address with a timestamp, hashing value of a session, entry number, creation of a sequence/ID number that must thereafter be used by the consumer (200), etc., etc., can be several suggestions as a method for this. The method for establishing such a campaign entry record will not be discussed here further as this can be implemented and determined by those skilled in the art.

The computer implemented consumer engagement system (100) has means and interfaces (202) on which the consumer (200) can perform his/her actions for submitting a participation/qualification request (301) in order to participate in the campaign (306) based on the unique code (401) on the product item (402), and in most cases the user utilizes a computer implemented client (202) such as a phone app (202) for this purpose. This is typically achieved by using a phone app (202) or a website (202) for submitting the required information in a campaign entering request (301). The current invention is not concerned with details of these interfaces and methods on system interactions, as they can be implemented by those skilled in the art.

The current invention is not concerned with how a potentially qualifiable user/consumer (201) which receives a campaign participation invitation (305) submits and acquires her position (602) or time t (508) for qualifying as a qualified recipient (203), as this is solved and implemented in the system by those skilled in the art.

In Addition to the Conditions of:
the geolocation condition (600): the geographical positon (602) to fit the geolocation (601),
the time condition (500): point of time (608) within the time span (608), and
the pool condition (400): that the unique code (401) on the product item (602) to be in the pool (404) of unique codes (401), or unique codes (401) specifically used for the campaign (306), additional rules and/or conditions (607) might be created in the consumer engagement system (100). These additional conditions (607) can be divided into two main groups:

Firstly, conditions for being accepted for participation and for being registered on the execution list (710). These can involve any parameters or rules that the brand owner deems useful. Examples of such rules and conditions are that a participating consumer (200) must be over the age of 18, be resident in the state of California, or New York, have at least purchased at least one product item (402) having a unique code (401), prior to or upon entering the current campaign (306), be a member of a club or association, not be an employee of the brand owner, and so and so on. These rules and conditions (607) are then also associated with the named campaign (306) and managed by the consumer engagement system (100) during the execution of the campaign (306). The extent and purpose of these conditions (607) are up to the brand owner.

The second type of conditions (323) are concerned with the actual response (333) that will be given to the consumer (200) when and after being accepted and admitted to the execution list (710). These rules (323) in fact determine how a user profile (201) and status will be benefited in a differential way individually, based on their profile data (201). Imagine, what is quite normal, without elaborating how they were reaching their respective statuses:
consumer Adam has a “Gold” status, and
consumer Bill has a “Bronze” status.

All else being equal, for the same unique code (401) on a product item for a named campaign (306), Bill will in a drawing be awarded one “raffle” ticket (303) as a campaign offer (303), while if Adam used the same unique code (401) acquired from the product item (402) in the same campaign (306), he would be receiving ten raffle tickets/campaign offer (303) as his campaign offer (303) due to his gold status (201), and thus increase his winning chances.

Once the named campaign (306) has been designed and configured, the brand owner can release and execute the campaign (306) based on the unique code pool (404). The number of unique codes (401) in the code pool (404) depends roughly on the number of available product items (402), and the size and nature of the geolocation (601). Imagine the product items (402) to be a Brand's fuzzy drink bottles (402), and the geolocation (601) to be the entire USA, in order to reach the entire American audience of the Super Bowl event, and the time span to include the duration of the Super Bowl event. Depending on whether the campaign was restricted to only bottles (402) specifically marked for being for sale at the stadium during the Super Bowl event or not, the pool (404) could be significantly smaller if the geolocation (601) was limited to the borders (622) of the Super Bowl stadium.

Following the lines of the above consumer statuses, one may imagine that Bill, previously having a “Bronze” status, used the same unique code (401) acquired from the product item (402) in the same campaign (306), and qualifying to a further, narrower secondary geolocation criterium (600) of being not only within the geolocation (601) of the USA, but also within the secondary geolocation (601) of the Superbowl Stadium, he would be upgraded to “Silver” status and receiving five raffle tickets/campaign offer (303) as his campaign offer (303) due to his newly acquired Silver status (201), and thus increase his winning chances.

The consumer engagement system (100) will via the client (202) now start receiving requests (301) from consumers (200) that want to get registered on the execution list (710) by a qualifying process that is governed and managed by the total configurations and rules for the execution for the consumer engagement system (100). The first step is that a consumer (200) via appropriate means and interfaces, such as a client (202), communicating with the consumer engagement system (100), submits a unique code (401) acquired from a product item (402) in the unique code pool (404). The unique code (401) and context information will be stored in the consumer engagement system (100). In some cases, due to the set up of the rules and conditions (600, 500, 507, 700), the request based on the unique code (401) is qualified and advanced to the execution list (710) at once. However, in many other cases, the consumer engagement system (100) is constantly managing incoming information and processing qualifying interactions.

As the requests (300) from consumers (200) are received by the consumer engagement system (100), for the requests (300) that result in a qualified request (301), the consumers (200) are qualified by the consumer engagement system (100) and are advanced to the execution list (710).

The actual execution has at least two modes depending on the design of the campaign (306). In an embodiment of the invention, firstly there is an essentially immediate response back to the consumer at the time of qualification. For instance, during Boxing Day only, a campaign (306) is being operated. The campaign participation invitation (305) that is given out to all participants (200) is a 1 to 5 chance to win a free cup of coffee. By simply by sending a unique code (401) on a product from the campaign unique code pool (404), when the qualification request (300) is received by the consumer engagement system (100) from a consumer (200) and accepted, the drawing is executed (individually) for that given consumer (200) at once. The consumer (200) will thus at once receive the response, the campaign offer (303) whether or not he/she won a cup of coffee.

The second type is where the execution is done later and the response will be handled with a group of qualified consumers (200). An example of this second type of response is where all ticket holders during an event, that have been qualified, are taking part in a prize drawing at a given minute.

The criteria are mutually independent. The unique code (401) is the “ticket.” The criteria (geolocation 600, time 500, and unique code 400) may be cumulative: The code may have been scanned in Alaska, within the geolocation (601) USA, the time may be 5 years later, within the time span of a campaign, and the person (201) may already be on the list (710).

The term “unique code” (401) on the product (402) must be according to real track & trace: the person (200), (201) must participate with a unique code (401) and satisfy the criteria. The unique code (401) must be unique in the understanding that one unique code (401) is used to mark only one product (402) at a packaging unit level.

### Embodiments of the Current Invention

Embodiments of the invention have the following steps and components.

A brand owner creates a named campaign (306) that they decide to run. A part of setting up the campaign (306) is to define and specify the campaign offering (303), i.e. what is the award(s) and value that the qualified consumers (203) will be receiving/have delivered (if qualified). Also, as a part of the setting up and preparing the campaign (306) is to specify and define the conditions (600, 500, 400, 606, 607) that must be passed/met by the qualifiable consumer (201) in order to receive the campaign offer (303). The consumer (200) engagement system (100) will (if so required), based on the created campaign (306), create and manage a pool (404) of unique codes (401). The unique codes (401) will be (or is selected from a number of already marked unique codes (401)) transferred to a production and packaging facility (102), whereby the product items (402) will be (or have been) marked with the unique codes (401) and shipped to the market. Note, however, that the pool (404) of unique codes (401) for marking product items (401) does not have to be purpose generated for the consumer engagement system (100) according to this invention. In most situations the unique codes (401) on product items (402) (the code pool (404)) are already in the market and are managed by the coupled track and trace system (101) for an array of other track and trace reasons and purposes—such as aggregated track and trace, for example. In this situation the consumer engagement system (100) adds or “captures” the applicable unique codes (401) to the unique code pool (404). The code and product pool (404) naturally can be composed of any number and combinations of GTINs and identifiable products items based on whatever parameters that might be commanded by the track and trace system in order identify and manage such a collection pool (404) of unique codes (401)—such as production time, Lot no(s), expiry date, customer (such as Walmart), etc. The campaign (306) is now prepared and can be initiated, executed and “in operation.” The consumer interaction system (100) is arranged to send a campaign participation invitation (305) to potentially qualifiable consumers (200, 201), and does so. The participation invitation (305) may be a public advertisement, or a participation invitation transmitted individually to one or more or all potentially qualifiable consumers (200, 201) such as via an sms, a mail, or the device (202) in possession of the qualifiable consumer (201). The campaign participation invitation (305) may also be a TV advertisement, a billboard posted invitation, an electronic board posted campaign invitation (305) such as on a screen on the geolocation (601), on an entry ticket, etc.

Consumers (200) can now, as a response to the participation invitation (305), begin scanning product items (402) with unique codes (401) and submitting and communicating the code as submitted code (403) to the consumer engagement system (100) to take part in the campaign (306). Every transaction between the consumer (200) and via their client or device (202) will be processed by the consumer engagement system (100) that will control that the submitted code (403), code (401) is an authentic code and further is within the assigned and managed code pool (400), and that the conditions (600, 500, 606, 607) are met. If they are met, the consumer (200) which is now a qualified consumer (303) is pushed to and registered in the execution register (710).

At the appropriate time, when the consumer engagement system (100) will, by using the execution register (710) as the data source, start delivering the value, the campaign offer (303), to therein qualified consumers (200, 203). As a part of delivering the value, the campaign offer (303) to the individual qualified consumer (200, 203), the consumer profile (201) is retrieved and accessed from the consumer profile database in the consumer engagement system (100), and then this profile (201) is used to determine what is the correct value included in the campaign offer (303) that shall be delivered to the consumer (200) based on that consumer profile data.

### Further Description on Embodiments of the Invention

For describing the invention further, consider the following example. The Superbowl is an event for which such a special campaign (306) can be used. A major brand (BigBrand) has sponsored the event and wants to maximize its investment by also engaging consumers (200) by using the current invention and serialized product items (402).

BigBrand has designed a special campaign (306) that will be run around and during the time of the Superbowl. The campaign (306) in this example will have several components that are targeted towards different groups of consumers (200) and their call to action in the form of distribution of a campaign participation invitation (305) and may differ greatly—however all of them will involve the use of a unique code (401) on product items (402) sold by BigBrand.

BigBrand has planned consumer Element A, where during the Superbowl each consumer (200) or fan on the stadium premises/location, a geolocation (601) can participate in a campaign (306) with a drawing to potentially win prizes (304). This campaign (306) with a drawing for a prize which will be part of a campaign offer (303) will be announced using a campaign participation invitation (305) either in advertisements or stadium messages, text messages to individuals present, etc. One prize drawn as a result of the campaign offer (303) is that one fan/consumer (200) will meet their favorite team immediately after the game. Naturally BigBrand only wants fans present at the stadium to win this prize and in such a way maximize the exposure of the happily winning fan. The drawing for this prize (304) thus has the geolocation condition (600) that the consumer (200) naturally must be present in the stadium during the Superbowl game to be put on the list (306) that will be used to draw the winners. Additionally, technically the consumer as another time criterium/condition (500) must be at the stadium at a given time period (506).

For the given example, the criteria for this event campaign (306) is the geolocation criterium (600): that the consumer (200) is registered to be present at the stadium, the geolocation (601) if such proof is validated, and the time condition (500): where the registration time, the point of time (508) is open in the time range (506) one hour before the game begins and the registration closes five minutes before the game is over. The consumer (200) is then added to the execution register (710). One omnipresent criteria and condition that is essential is that the registration to participate is done by scanning or by some means submitting a unique code (401) on a serialized product item (402).

For a campaign (306), which codes (401) on which products items (402) might also be defined further within the scope of the current invention. For instance it might only be unique codes (401) used for a certain brand or product packaging category that allows participation, say the half liter bottle for a soft drink. This type of criteria and conditions for the unique code pool (404) is decided and configured for each campaign (306) by the brand owner.

In general, the invention has the following criteria definition; a unique code (401) on a product item, geolocation (601) when registering the unique code (401), a time (608) within a time period (606) for registering the unique code (401), and additional other criteria and conditions (607) that the brand owner wants to enforce or require.

An example of such additional criteria might be that the consumer (200) be above a certain age such as 18 years, or other parameters about the consumer (201) himself that might be required to be fulfilled, such as memberships. In the Superbowl example, for Element A, in that campaign (306) the fan, the consumer (200) must scan a unique code (401) from a soft drink bottle (402) at a point of time (408) during the time span (406) of one hour before the game begins and up to five minutes before the game ends, and be present in the stadium the geolocation (601) when scanning the unique code (401). The current invention is not concerned with the way or methods employed to check and verify that the campaign criteria are met. However, an app on a mobile phone is convenient for this purpose. The app might reference a geofence definition of the stadium and the time is determined by a clock, and the unique code on the scanned product item is checked by the track and trace system operated by the brand owner.

In order to illustrate how the current invention enables the brand owner to rapidly change the campaign (306) criteria and conditions and its configurations very quickly, let us consider the above Superbowl example again. In the above campaign (306) the consumer (200) was required to scan the unique code (401) on a product item (402) at a time (408) within a time window (406), starting one hour before the game and then up to five minutes before the end of the game.

However, in order to potentially engage consumers (200) in a broader way, using the current invention, the criteria controlling the point of time (408) could be altered. The criteria could be changed so that any of the relevant unique codes (401) from the pool (400) can be scanned by any consumer (200) at any geolocation (601′) in advance, starting in the three months leading up to the game. The number of scans and engaged consumers (200) meeting this criteria is, of course, significantly higher than the first configured campaign (306). However, to finally enter the drawing for prizes (304), from those having scanned the unique codes (401) in the three months period—only those who actually were present at the game, the strict geolocation (601) during the time window (406) one hour before and five minutes before the end of the game would make it in the drawing. However, during the Super bowl game (i.e., the time condition (500), only position/location (600) would be required to enter and/or be verified since a unique code already has been scanned earlier.

By the current invention, conditions for entering the campaign (306) might be “detached” and “independent” to each other in the way described above. However at the time of action, i.e. when the delivery of the campaign participation invitation (305) or the time for allowing participation requests (300) shall start or begin, all criteria must be met.

BigBrand has decided to run in the same campaign (306) another consumer engagement element B for the Super Bowl. This element of the campaign (306) is however not directed at the fans and consumers (200) present (606) at the stadium. A campaign participation invitation (305) may be publicized so that anyone can, during one hour before the game and until one hour after the game, scan any unique code (401) on their brands, and enter a drawing to win (303) a vacation and a brand new car. There will be only three winners of this top prize, but everyone scanning a code during this time will be offered 50% off all their purchases within the next week. The scanning and thus entering to get the reward is limited within the borders of the USA.

In an embodiment of the invention, said consumer engagement system (100) is arranged such that said potentially qualifiable recipient (201) cumulatively obtains said qualification criteria (a), the pool criterium, and (b), the geolocation condition criterium (600) independently of each other. The campaign participation invitation (305) may be sent to those who have already scanned their bottle, product code (401) e.g. several months before the event), and they only need to demonstrate that they are present within the geolocation (601) when sending their participation request (301).

As an example of the embodiment, the recipient (201, 202) provides a pre-obtained unique code (401) brought with him into a stadium which may be a position fulfilling the geolocation condition. In other words, the recipient (201) to be a qualified recipient (202) must have a product item (402), or more specifically have or provide the unique code (401) which must be in the pool (404) of product codes (401), and be at a position (602) within the right geolocation (600), and the potential recipient (201) must be at a so-called execution list (700). The potentially qualifiable recipient (201) may, e.g. during the time from Christmas and up until the finish of the SuperBowl game, have bought a lot of bottles, say 50 bottles, each with its unique code (401), all are registered either via his bank card during the purchase, or scanned from his bottle (402) before or during consumption, and thus the potential recipient (201) already has registered a large number of unique codes (401) before receiving the campaign offer (303), thus the criterium (400) may be fulfilled already before the SuperBowl arrangement starts. The brand owner may decide to set up the campaign at any time after (or before) anyone has scanned the code (401), e.g. just ahead of the SuperBowl arrangement, or a long time ahead of the game.

The campaign (306) has an offering (303) to the consumer (200). The offering (303) is the value that is promised to be delivered to the (200) consumer if participating and meeting all the conditions (600, 606, 607) for the named campaign (306). More accurately, offering (303) and it's value can be a collection of “sub-values” that are delivered according to campaign rules. For instance, in a raffle ticket drawing, there is only one Mercedes car that will be delivered to one lucky consumer (200), and 50,000 consumers (200) specially branded limited edition watches. In this case, the value is to be in the drawing and the prize that might be handed out. Another collection of value is where the value is “dependent” on the qualifying consumer, where gold status will have the brand owner deliver higher value to the consumer than one with bronze status.

More on how the rules are designed and managed

The offering can be individualized for each consumer based on their user profile.

The border (622) defines an enveloping control area wherein there is an inside and an outside that are distinguished. The geometrical shape and geographical or otherwise corner positions of the polygonal arrangement of the border (622) is according to the discretion of the implementing party. Several such enveloping control areas may be controlled. Each item (10) is identified by a unique code (30). One or more customer operated portable/handheld units (60) with a customer operated code scanner (66) are available to the customers for scanning/reading the unique code (10) marks on the items (10).

I claim:

1. A computer implemented consumer engagement system (100) for managing a campaign offer (303), comprising:
a computer implemented consumer engagement system (100); and
a pool (404) of unique codes (401) related to code marked product items (402), the code marked product items being associated with a campaign offer (303) of a campaign (306) in said consumer engagement system (100),
wherein said consumer engagement system (100) is arranged to manage at least one geolocation condition (600), and to deliver a campaign participation invitation (305) to a potential qualifiable recipient (201), wherein said potentially qualifiable recipient (201) in order to become a qualified recipient (202) for receiving said campaign offer (303), must meet the following qualification criteria:
(a) a pool criterium (400): said system receiving a unique product code (401) marked on a product item (402) from said recipient (201, 202), said code (401) being determined to be amongst said pool (404) of unique codes (401);
(b) a time criterium (500): that the consumer (200) sends his participation request (301), or accepts an invitation to participate at a point of time (508) within a first time period (506) defined in the campaign (306); and
(c) a geolocation condition (600) criterium: receiving proof or indications from the recipient (201, 202) being present and having a position (602) within a geolocation (601),
wherein said consumer engagement system is further arranged for, said qualifiable recipient (201), after receiving a campaign participation invitation (305), to receive from said qualifiable recipient (201) a participation request (301), or to accept said campaign participation invitation (305), and
wherein said consumer engagement system is further arranged to check whether the potentially qualifiable consumer (201) thus fulfills criteria (a), (b), and (c), thus becoming a qualified recipient (202), thus fulfilling:
(d) an execution list criterium (700): wherein the recipient (201, 202) is registered on an execution list (710) to receive said campaign offer (303).

2. The computer implemented system of claim 1, wherein said consumer engagement system (100) is arranged such that said potentially qualifiable recipient (201) cumulatively obtains said qualification criteria (a), the pool criterium (400), (b), the time criterium (500) and (c), the geolocation condition criterium (600) independently of each other.

3. The computer implemented system of claim 1, wherein two or more of said qualification criteria (a), the pool criterium (400), (b), the time criterium (500), (c), the geolocation condition criterium (600), and (d) the execution list criterium (700) are fulfilled simultaneously.

4. The computer implemented system of claim 1, wherein said offer (303) comprises a ticket in a lottery for a prize.

5. The computer implemented system of claim 1, wherein said campaign offer (303) comprises participation at an event, including meeting the winning team/home team after the game, watching the game from the VIP tribune.

6. The computer implemented system of claim 1, wherein said campaign offer (303) comprises a price discount, such as a price discount on another product item (402), a snack, a drink served at the geolocation (601).

7. A computer implemented consumer engagement method for managing a campaign offer (303), comprising, in a computer implemented consumer engagement system (100), the steps of:
establishing a pool (404) of unique codes (401) related to code marked product items (402) associated with a campaign offer (303) of a campaign (306) n said consumer engagement system (100); and
establishing in said consumer engagement system (100) the following qualification criteria (400, 500, 600) for a potentially qualifiable recipient (201):
(a) a pool criterium (400): whether a submitted code (403) is in said pool (404) of unique codes (401);
(b) a time criterium (500): whether the qualifiable recipient (201) sends a participation request (301) or accepts an invitation by submitting the participation request (301) within a first time period (506) defined in the campaign (306); and
(c) a geolocation (600) criterium: whether the potentially qualifiable recipient (201) provides a position (602) which is within a geolocation (601),
wherein said consumer engagement system (100) provides a campaign participation invitation (305) to said potentially qualifiable recipient (201),
wherein said consumer engagement system (100) receives a participation request (301) from said potentially qualifiable recipient (201) having been given said campaign participation invitation (305) in order to become a qualified recipient (202);
wherein said participation request (301) comprises:
a code (403) read from an item;
a point of time (508) for submitting the request (301); and
a position (602) of said potentially qualifiable recipient (201), and
wherein if said consumer engagement system (100) determines said potentially qualifiable recipient (201) meets said qualification criteria (400, 500, 600), the method further comprises the steps of:
determining said potentially qualifiable recipient (201) to fulfil an execution list criterium (700) and be a qualified recipient (202) to enter an execution list (710) to receive the campaign offer (303); and
delivering said campaign offer (303) to said qualified recipient (202).

8. The method of claim 7, wherein said potentially qualifiable recipient (201) cumulatively obtains said qualification criteria (a), the pool criterium (400), (b), the time criterium (500), and (c) the geolocation condition criterium (600) independently of each other.

9. The method of claim 7, wherein two or more of said qualification criteria (a), the pool criterium (400), (b), the time criterium (500), (c), the geolocation condition criterium (600), and (d), the execution list criterium (700) are fulfilled simultaneously.

10. The method of claim 7, wherein said campaign offer (303) comprises a ticket in a lottery for a prize.

11. The method of claim 7, wherein said campaign offer (303) comprises participation at an event, including meeting the winning team/home team after the game, watching the game from the VIP tribune.

12. The method of claim 7, wherein said campaign offer (303) comprises a price discount.
